(19) United States
(12) Patent Application Publication
(10) Pub. No.: US 2013/0318844 A1
(43) Pub. Date: Dec. 5, 2013

(54) SIGN APPARATUS AND METHOD

(71) Applicant: DUHAIME INCORPORATED, Independence, MN (US)

(72) Inventor: Dawn Duhaime Ohnstad, Independence, MN (US)

(73) Assignee: Duhaime Incorporated, Independence, MN (US)

(21) Appl. No.: 13/837,016

(22) Filed: Mar. 15, 2013

Related U.S. Application Data
(60) Provisional application No. 61/654,488, filed on Jun. 1, 2012.

(51) Int. Cl. G09F 15/00

(52) U.S. Cl. CPC G09F 15/0081; G09F 15/0075
USPC 40/607.01

(57) ABSTRACT

A real estate sign post apparatus comprises a sleeve configured to wrap about a post, a cap configured to be coupled to an end of the sleeve, and a sign coupled at least one of the sleeve or cap. The cap can be configured to fix a position of the sleeve on the post. When assembled, the sign can extend from a side of the post.

### CLAIM OF PRIORITY

This application claims the benefit of priority under 35 U.S.C. §119(e) of Ohnstad, U.S. Provisional Patent Application Ser. No. 61/654,488, entitled “REAL ESTATE SIGN POST APPARATUS”, filed on Jun. 1, 2012, which is herein incorporated by reference in its entirety.

### BACKGROUND

Real estate signage is typically placed on a street side of a property for sale or rent. Real estate signs can include information pertaining to the property or the person or agent that a perspective buyer can contact. For example, a real estate sign can be oriented with the information facing perpendicular to the road so that a perspective buyer can ascertain the information while driving by the property from either direction.

Typically, real estate signs are positioned by real estate posts anchored in the ground or stabilized by a base. Real estate posts can be rented from a real estate post services company. The posts can then be removed by the real estate post services company after the property has been sold or rented.

U.S. Pat. No. 6,547,197 is directed to a bracket configured to be tightened around a post. Particularly, the bracket can support a rod used to hold items over a sign attached to the post.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1 and 2 are views of a real estate sign post apparatus.

FIG. 3 is a perspective view of the sleeve of the real estate sign post apparatus of FIGS. 1 and 2.

FIG. 4 is a perspective view of the real estate sign post apparatus assembled to the real estate sign post.

FIG. 5 is a flow chart of an example of a method of providing real estate information.

### DETAILED DESCRIPTION

The present disclosure relates generally to sign post apparatuses and methods. For example, the sign post can include any post capable of displaying information, such as a reals estate sign post, auction sign post, marketing sign post, advertisement sign post, or the like. For ease of reading, a real estate sign post is used throughout as an exemplary sign post apparatus. The real estate sign apparatus can include a sleeve configured to wrap about a post and a cap configured to be coupled to an end of the sleeve. The cap can be configured to fix a position of the sleeve on the post. A signboard can be coupled to at least one of the sleeve or cap, such that the sign can extend, for instance laterally, from a side of the post.

A real estate signboard can be used to inform potential buyers regarding details of a property, such as contact information for an agent or seller, status of sale, type of sale, or the like. The real estate signboard can be double sided, such that the property details are perpendicular to a roadway. That is, the real estate signboard can be placed so as to be observable by a potential buyer heading either direction along a roadway.

A real estate signboard can be supported by a real estate sign post, such as a post or rod. A real estate sign post can include a post anchored in the ground, stabilized by a base, attached to a tree, attached to a bush, or attached to a house. A cross-bar can extend outwardly from the post. The cross-bar can be configured to hang or attach the real estate sign perpendicular to the roadway. Such real estate sign posts can be relatively readily readable, for example readable in a time period that the sign is in view of a motorist or passenger in a passing vehicle, or in a time period that the sign is in view of a mobile device sufficient for the mobile device to take a picture, read, scan, or similarly discern the real estate sign post.

Embodiments of the present disclosure include a real estate sign post apparatus that can orientate a real estate signboard on an already existing real estate sign post, so that the real estate signboard is parallel to a roadway. Benefits of such embodiment include, but are not limited to, ability to display additional quick read information to a potential buyer, an increase in the time a potential buyer can observe property information, additional space or forms of information can be displayed, or the like. Further, a user can use a mobile device to scan or take a picture of the real estate sign post apparatus while in a motor vehicle that links the mobile device to the internet, such that the user can access information regarding a property without having to exit the motor vehicle.

Typically real estate sign posts can be rented from a real estate sign post services company, such as by contract. The contract can include a clause that prohibits the renter from destroying or otherwise materially altering the real estate post. Benefits of the present subject matter includes, but are not limited to, providing further signage opportunities on an existing real estate sign post without materially altering the post.

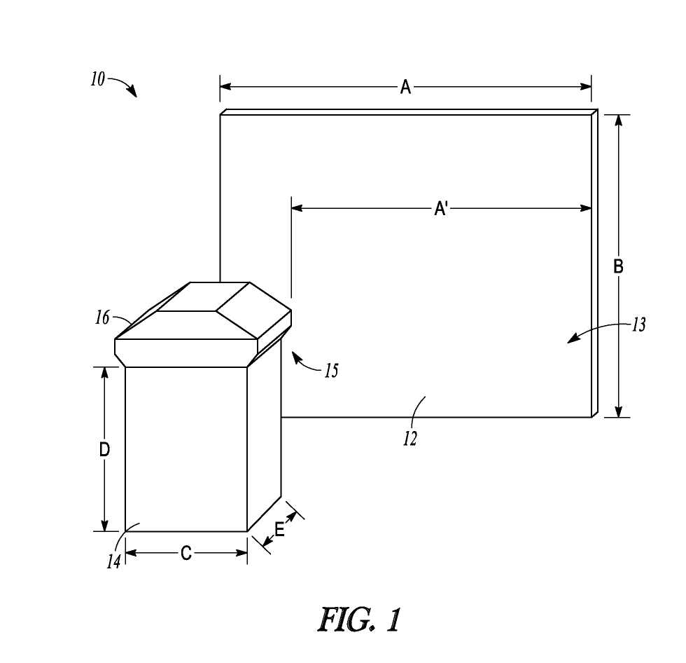

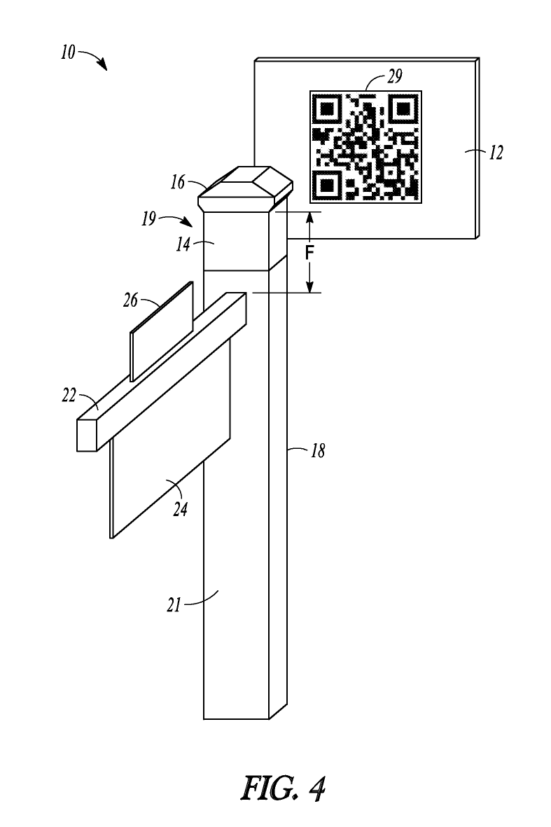

FIG. 1 is a perspective view illustrating a real estate sign post apparatus 10. Real estate sign post apparatus 10 can include a sleeve 14 configured to wrap about a post, as illustrated in FIG. 4. The sleeve 14 can include one or more living hinges, as discussed in relation to FIG. 2. The sleeve can be formed from a weather resistant material, such as a plastic, including polyethylene, polypropylene, or the like. The plastic can be corrugated plastic, such as typically used in commercial signs or plastic containers.

The sleeve can include a width C or a depth E such that the sleeve can wrap about (e.g., slide over) the post. The post can include a square cross section, hexagonal cross section, circular cross section, or the like. For example, the width C or depth E can be configured so as to wrap about a 4 inch by 4 inch post, as typically used in the industry. The post can include a metal or polymer rod, stud, stake, or similar object of any geometry configurable to be inserted or be placed on the ground to establish a substantially vertical position of the apparatus. The post can include any suitable construction material, including wood, metal, or a polymer.

A cap 16 can be coupled to an end 15 of the sleeve 14. The cap 16 can be configured to fix a position of the sleeve 14 on the post. Said another way, the cap 16 can be configured to hold the signboard 12 in a selected position on the post. For example, the cap 16 can sit on an end of the post not anchored in the ground, as discussed in reference to FIG. 4. The cap 16 can sit on the post without the use of an adhesive or a fastener. That is the cap 16 can be placed on the post without materially damaging or altering the post, such as a slip over cap.

The cap 16 can be formed of a weather resistant material, such as treated wood, plastic, stainless steel, copper, powder coated aluminum, or the like. In an example, the cap 16 can include a solar light cap for powering an auxiliary light to illuminate the real estate sign or real estate post, or the like.

The cap 16 and sleeve 14 can be a unitary assembly, such as an injected molded assembly, including polyethylene, polypropylene, or the like. In an example the cap 16 can be snap fit or press fit to the end 15 of the sleeve 14. Alternatively, the cap 16 can be coupled to the end 15 of the sleeve 14 by an adhesive, such as a weather resistant adhesive. For example, a weather resistant adhesive can include an adhesive typically used in the construction industry.

A signboard 12 can be coupled to the sleeve 14 or cap 16, such that the signboard 12 extends from a side of the post, as described in relation to FIG. 4. For example, the signboard 12 can be facing (e.g., parallel to) the roadway so as to be ascertainable and/or technologically accessible by a potential buyer positioned in front of the real estate sign post, such as on foot, personal transportation (e.g., bicycle), or a motor vehicle. The signboard 12 can have a length A and a width B, such that the signboard 12 can be visible or scannable by a mobile device from a roadway. In an example, the length A can be about 12 inches and the width B can be about 10 inches. The signboard 12 can be coupled to the cap 16 or sleeve 14 such that an overlap of the signboard 12 on the posterior side (e.g., the side of the sleeve 14 not shown in FIG. 1) of the post can provide an approximate square signboard 12. In an example, a front of the signboard 12 can include the side of the signboard adjacent the sleeve, wherein the back of the signboard is opposite the front. Continuing the previous example, the signboard 12 can include about 2 inches of overlap so that the sign includes a visible length A′ of about 10 inches and a width of about 10 inches.

The signboard 12 can be formed of a weather resistant material, as described herein, such as vinyl poster board. The sign can be formed from a flexible material, so as to bend or move in the wind without breaking or snapping. At least one surface of the signboard 13 can be coated with a substance configured to aid in removal of a sticker 29 (FIG. 4). For example, one surface of the signboard 13, such as the front side, can face the road. Additionally or alternatively, the surface of the signboard 13 can include a texture configured to aid in adhesion. The sticker 29 can include property information, as described herein, or link information, such as a web site address, a quick response code (QR code), telephone number, or the like. The link information can provide a link to a website, a video of the property, a video guided tour by a real estate agent or similar individual, a virtual tour, or the like. The link information can further direct a user to a website, a video, or the like, such that a user can initiate contact with a real estate agent, steward of the property, or the like. For example, the website can permit a user to leave contact information for the real estate agent, steward of the property, or the like, to initiate contact with the user. In an example, the sticker 29 (FIG. 4) can include a QR code scannable with a mobile device from a range of about 6 feet to about 20 feet, such as from a sidewalk or roadway. The sticker 29 can include a QR code, scannable from about 15 feet away, substantially centered on the visible portion of the sign and a QR code, scannable from about less than 3 feet, in a corner of the visible portion of the signboard. In an example, the sticker 29 can be fixably attached to the signboard 12, such that the sticker 29 is non-removable.

Alternatively or in addition to the sticker 29, as described herein, the signboard 12 can be formed of a material configured to be printed on. For example, a QR code conveying real estate information can be printed on the visible section of the signboard 12, such as A′ by B in FIG. 1. The sticker 29 or printed code or linked information can, for example, be altered remotely. For example, the linked information to the QR code, when scanned, can be remotely changed to direct a user from a first link or website to a second link or website.

The signboard 12 can include one or more attachment locations configured to attach the signboard 12 to at least one of the cap 16 and the sleeve 14. For example, the signboard 12 can attach in a corner of the signboard 12 or in approximately in the middle of the signboard 12. The attachment locations can include a tongue and groove assembly, for example, or can be part of a unitary assembly as described herein. The informational sheet on the signboard 12 can include property information or link information, as described herein. The attachment locations can be configured so as to permit the informational sheet to be readily detached.

FIG. 2 is a perspective view illustrating a real estate sign post apparatus 10 (FIG. 1). As illustrated in FIG. 2, the signboard 12 is coupled to the cap 16 by a bracket 18. The bracket 18 is attached to the cap 16 so as to not alter or destroy the post, as discussed in reference to FIG. 4. The signboard 12 can be coupled to at least the cap 16 or sleeve 14 by a holding mechanism, such that the sign can slide, snap, or press into the holding mechanism. For example, the holding mechanism can allow for interchangeability of multiple signboards, such as a different sized signboard, a signboard of different material, a signboard with different information, a signboard of any shape, a signboard of a different configuration, a repaired or new signboard to replace a damaged signboard, or the like. The holding mechanism can include a tongue groove assembly or similar assembly configured to snap, slide, or press fit.

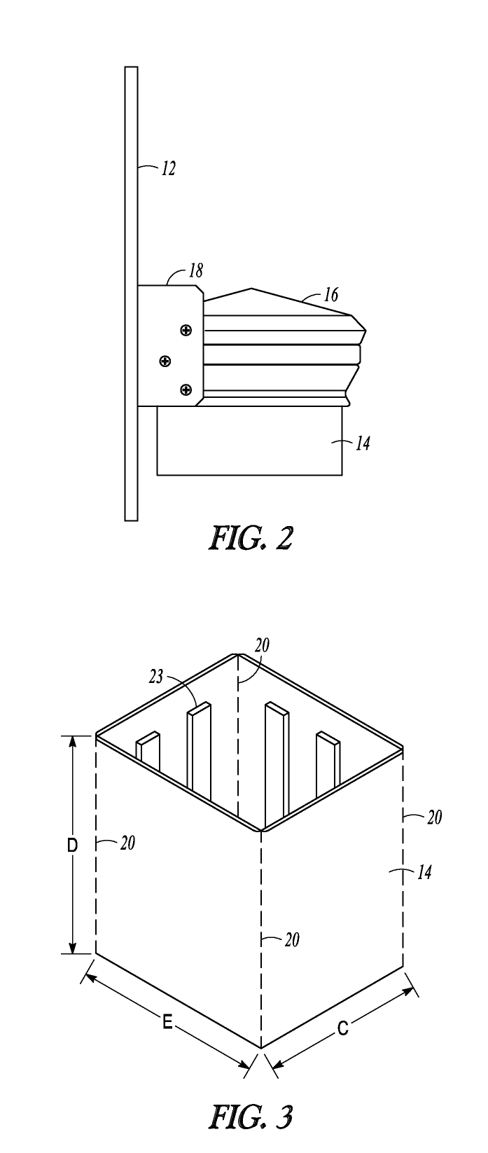

FIG. 3 is a perspective view of the sleeve 14 of the real estate sign post apparatus 10. Sleeve 14 can include one or more living hinges 20, such as a relatively thin, as compared to the rest of the sleeve 14, flexible hinge made from the same material as the sleeve 14. The one or more living hinges 20 can be configured so as to permit the sleeve to fold flat for shipping, storage, or the like. The one or more living hinges 20 can correspond to the shape of the post, as discussed in relation to FIG. 4. In an example, one or more living hinge 20 can include further attachment means such as tape.

Sleeve 14 can include a length D configured to stabilize the cap 16 or signboard 12, such as in weather or during assembly or disassembly. The length D of the sleeve 14 can include a length of at least about 2.25 inches to about the distance F from the cap 16 to the cross bar 22, as illustrated in FIG. 4. The sleeve can be configured to be transparent, decoratively colored, or be the same color as the post 18.

In an example, an interior surface of the sleeve 14, such as the surface that contacts the real estate sign post, can include one or more pads 23 configured to secure the real estate sign post apparatus to the post. The pads 23 can be tacky or provide grip, without materially altering the real estate sign post.

FIG. 4 is a perspective view of the real estate sign post apparatus 10 assembled to a real estate sign post 18. The real estate sign post apparatus 10 can include a unitary assembly configured to couple to the real estate sign post 18. For example, the unitary assembly can include the sleeve 14 and the cap 16, wherein the sleeve 14 can be configured to passively wrap about the real estate sign post. Passively includes non-material alteration of the real estate sign post. The cap 16 can be configured to fix a position of the sleeve 14 on the real estate sign post 18, such as on a distal end 19 (e.g., an end vertically disposed from a buried end) of the real estate sign post 18. The real estate sign post apparatus 10 can be assembled such that a broad side of the signboard 12 is facing (e.g., parallel to) the roadway, as described herein. The real estate sign post 18 can include a cross bar 22 extending laterally from a side 21. The side 21 can face a roadway, such that the cross bar 22 is substantially perpendicular to a roadway. The cross bar 22 can include an informational sign 24 or an auxiliary informational sign 26.

The signboard 12 can include a sticker 29, such as a QR code sticker, as described herein. In an example, the sticker 29 can be made of a weather proof material configured to withpost the climate of the geographical location that the real estate sign post apparatus 10 is installed. Further, the sticker 29 can be fixably attached to the sign 12, such that the sticker 29 is substantially non-removable. For example, the sticker 29 can include a QR link that can be remotely changed. Such an example can provide the benefit of reusing the sticker 29 or signboard 12.

In an example, the unitary assembly can include the sleeve 14, cap 16 and signboard 12, such that the unitary assembly can be injection molded as one piece configured to be coupled to a real estate post 18. In an example, the unitary assembly can be formed of acrylic or similar materials.

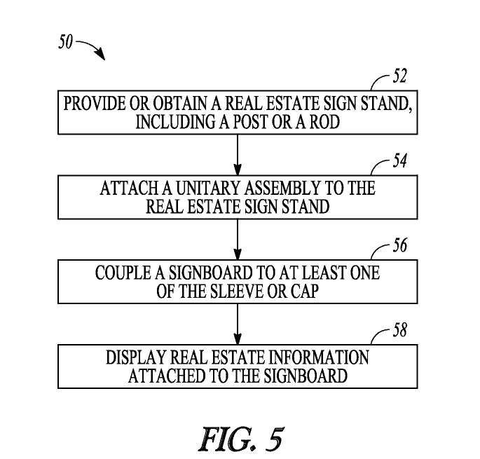

FIG. 5 is a flow chart of an example of a method 50 of providing real estate information. In describing the method 50 reference is made to features and elements previously described herein, including numbered references. Where convenient, numbered elements provided within the description of the method 50 are not intended to be limiting, instead numbered references are provided for convenience and further include any similar features described herein, as well as their equivalents. At 52 the method 50 can include providing or obtaining a real estate sign post, including a post or a rod, such as the real estate sign post 18. The real estate sign post can be inserted or positioned on a yard or the like. At 54 the method 50 can include attaching a unitary assembly to the real estate sign post, the unitary assembly including a sleeve 14 and a cap 16. Attaching the unitary assembly can include passively wrapping the sleeve about the real estate sign post and fixing a position of the cap with the sleeve passively wrapped on the real estate sign post.

At 56, the method 50 can include coupling a signboard 12 to at least one of the sleeve or cap, the signboard extending from a side of the post. As described herein, the signboard 12 can be coupled at a variety of locations, such as an edge or middle of the signboard 12. Further, at 58 the method 50 can include displaying real estate information attached to the signboard 12. For example, the information can be displayed using a QR code, lettering, pictures, or any combination thereof, as described herein. The displayed information can include a sticker 29 or some other adhered information, or the displayed information can be printed directly on the signboard 12, such as on the surface 13. The link associated with the displayed information can be modified remotely, such as by a computer, mobile device, or the like. For example, when scanned, the QR code can direct a user or a user's mobile device to a first website. The link to the first website can be remotely changed to a link of a second website. Benefits of such an example include versatility of a single code of displayed information, such that the same code can be used multiple times.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the underposting that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim posting on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A sign post apparatus, comprising:
a sleeve configured to wrap about a post;
a cap configured to be coupled to an end of the sleeve, the cap configured to fix a position of the sleeve on the post; and
a signboard, configured to be coupled to at least one of the sleeve or cap, the sign extending from a side of the post.

2. The apparatus of claim 1, wherein the sleeve includes one or more living hinges.

3. The apparatus of claim 1, wherein the sign is rotatably coupled to at least one of the sleeve or cap.

4. The apparatus of claim 1, wherein at least one of the sleeve or cap is formed of polyethylene or polypropylene.

5. The apparatus of any one of claims 1, wherein the sleeve is formed of a corrugated plastic.

6. The apparatus of any one of claims 1, wherein a length of the sleeve is configured to stabilize the cap or sign.

7. The apparatus of claim 5, wherein the length is at least about 2 inches.

8. The apparatus of claim 1, wherein the sleeve includes one or more pads on an inner surface of the cap, the one or more pads configured to secure the real estate sign post apparatus to the post.

9. The apparatus of any one of claims 1, wherein the cap is press fit to the end of the sleeve.

10. The apparatus of any one of claims 1, wherein the cap and sleeve are a unitary injected molded assembly.

11. The apparatus of any one of claims 1, wherein the signboard is formed of a flexible material.

12. The apparatus of any one of claims 1, wherein the sign is formed of vinyl poster board.

13. The apparatus of any one of claims 1, wherein at least one surface of the signboard is coated with a substance configured to aid in removal of a sticker.

14. The apparatus of any one of claims 1, wherein the signboard includes one or more attachment locations, the one or more attachment locations configured to attach the signboard to at least one of the sleeve and cap.

15. The apparatus of any one of claims 1, wherein the signboard is configured to display a quick response code.

16. The apparatus of any one of claims 1, wherein the signboard is formed of a weather resistant material.

17. The apparatus of any one of claims 1, wherein the cap is a solar lighting cap.

18. A method of displaying information, comprising:
providing or obtaining a sign post, including a post or a rod;
attaching a unitary assembly to the sign post, the unitary assembly forming a sleeve and a cap, attaching the unitary assembly including:
passively wrapping the sleeve about the sign post; and
fixing a position of the cap with the sleeve passively wrapped on the real estate sign post;
coupling a signboard to at least one of the sleeve or cap, the signboard extending from a side of the post; and
displaying information attached to the signboard.

19. The method of claim 18, comprising remotely modifying the information displayed on the signboard.

20. A real estate sign post apparatus, comprising:
a real estate sign post, including a post or a rod;
a unitary assembly configured to couple to the real estate sign post, the unitary assembly forming a sleeve and a cap, wherein the sleeve is configured to passively wrap about the real estate sign post, wherein the cap is configured to fix a position of the sleeve on the real estate sign post; and
a signboard, configured to be coupled to at least one of the sleeve or cap, the signboard extending from a side of the post.
